(19) United States
(12) Patent Application Publication
(10) Pub. No.: US 2023/0222352 A1
(43) Pub. Date: Jul. 13, 2023

(54) Method for Training a Data-Based Evaluation Model

(71) Applicant: Robert Bosch GmbH, Stuttgart (DE)

(72) Inventors: Konrad Groh, Stuttgart (DE); Matthias Woehrle, Bietigheim-Bissingen (DE)

(21) Appl. No.: 18/154,132

(22) Filed: Jan. 13, 2023

(30) Foreign Application Priority Data
Jan. 13, 2022 (DE) 10 2022 200 287.3

(51) Int. Cl. G06N 3/09

(52) U.S. Cl. CPC G06N 3/09

(57) ABSTRACT

A method is for training a data-based evaluation model for determining an evaluation result. The method includes providing training data sets that assign input data sets to one or more labels, and determining a distribution interval of values of all the input data sets. The method further includes performing an initial determination of model parameters for the data-based evaluation model as a function of the distribution interval, and training the data-based evaluation model with the training data sets by further adaptation of the model parameters.

This application claims priority under 35 U.S.C. § 119 to patent application no. DE 10 2022 200 287.3, filed on Jan. 13, 2022 in Germany, the disclosure of which is incorporated herein by reference in its entirety.

The disclosure relates to a method for providing an evaluation model for evaluating non-normalized input data, and in particular sensor data.

### BACKGROUND

Deep neural networks can be used as regression or classification models in many fields of technology. Usually, they are used to map input data which result from scanning by sensors onto one or more regression values or onto one or more classes in order to thus be able to carry out a regression or classification.

Training such deep neural networks is often lengthy and requires providing a plurality of training data sets that assign combinations of input features to a model output in each case. The training method used is usually a back-propagation-based method, which is frequently very lengthy and scales significantly with the number of training data sets.

### SUMMARY

According to the disclosure, there is provided a method for training a deep neural network for use as a regression or classification model and a corresponding device.

According to a first aspect, a method for training a data-based evaluation model for a determination of an evaluation result is provided, having the following steps:

providing training data sets that assign input data sets to one or more labels;

determining a distribution interval of the values of all input data sets;

initial determination of model parameters for the data-based evaluation model as a function of the distribution interval; and

training the data-based evaluation model with the training data sets by further adaptation of the model parameters, in particular using a gradient-based training method.

The data-based evaluation model may correspond to a neural network, wherein the model parameters are provided for each layer of artificial neurons as elements of a weighting matrix and of a bias vector. The evaluation model is used to assign an input vector to an evaluation result, and in particular an output vector.

A conventional configuration of an artificial deep neural network consists in the arrangement of artificial neurons in one or more layers. The neurons of a layer execute a calculation rule in which, in each case, a sum of output values of neurons, weighted with weighting values, of a previous layer, or of an input vector, and a bias value is determined, and an activation function is applied to the result. The weighting values and bias values of a layer of the neurons are generally combined to form a weighting matrix, or a bias vector.

The training of such a data-based evaluation model, which is realized in the form of a neural network, can accordingly take place with a back-propagation method known per se based on predetermined training data sets. The training data sets each correspond to an assignment of an input data set to at least one label. These training methods are generally very time-consuming. So that the training method converges faster, it includes, as one of the first steps, an initialization of the weighting matrices and bias vectors of the individual layers of the neural network by randomly taking the elements of the weighting matrices and bias vectors of each neuron layer from a normalized Gaussian distribution.

This initialization typically takes place based on the assumption that the input data are normalized. During the normalization of the input data sets of the training data sets, an average value and the standard deviation of the elements of the input data sets are determined, and these features are normalized accordingly to the average value of 0 and a standard deviation of 1. To this end, the mean value determined in this way is subtracted from each element of the input data sets and then divided by the standard deviation.

For example, in the case of an image classifier for an RGB image, the color channels can be normalized as input data set by determining the average and the standard deviation of all values of a color channel over all the pixels and all training images of the training data, and normalizing the color channel of the training images by subtracting the mean value thus determined from each pixel value and then dividing it by the standard deviation. This results in a value for each pixel of between −1 and 1.

Furthermore, the distribution interval can be determined as a function of a minimum and a maximum value of all elements of the input data sets, wherein in particular the distribution interval is determined as a function of an average value and a standard deviation of the values of all elements of the input data sets.

For the initial determination of the model parameters for the data-based evaluation model, the following steps can be carried out:

determining a transformation function for mapping an assumed normalized input data set with a predetermined normalized distribution onto the distribution of the values of the elements of the input data sets;

specifying preliminary model parameters according to a random selection from a Gaussian normal distribution;

applying the transformation function to the preliminary model parameters to obtain transformed model parameters; and

initializing the neural network with the transformed model parameters.

Initializing the weighting matrix by a random selection from a normalized Gaussian distribution is generally advantageous for elements of the input data that are likewise normalized according to a normalized Gaussian distribution, in order to achieve a fast training. However, if the distribution of the values of the elements of the input data deviates from the normalized Gaussian distribution, this may result in slower training, depending on the selection of the activation function. In particular, in the case of a deviating distribution of the values of the elements of the input data, the use of a ReLU function as activation function leads to a lower utilization of the nonlinear behavior of the ReLU function, the effect of which otherwise contributes significantly to an accelerated training.

For input data sets whose values are not distributed equally, as can be the case for example with mixed physical inputs, i.e., the value ranges of elements of an input data set representing different physical variables are different, the normalization of the input data sets can result in a shift of the values of the individual elements of the input data sets.

In this regard, the initialization of the values of the weighting matrices and the bias vectors of one or more of the layers of neurons are adapted to the statistic of the value distribution of the elements of the input data sets, and thus the neural network is quickly enabled to learn the characteristic starting from an optimized initial state. Furthermore, a normalization layer is thus, optionally, omitted, which is advantageous in particular in embedded systems, because computing time for the evaluation of the neural network can be saved. In particular, the adaptation of the initialization of the weighting matrices and the bias vectors of the layers of the neural network leads to a faster model training. The adaptation takes place as a function of the distribution of the values of the input features.

The distribution of the elements of the input data sets is essentially determined by the value range of the elements. As a rule, an initialization of the weighting matrices and the bias vectors by random selection from a normalized Gaussian distribution for input features from a value range of from −1 to 1 leads to good training results, since the elements of the input data sets are generally also in the value range between −1 and 1. In these cases, training takes place with rapid convergence. Given an optimized normalized distribution of the input features between −1 and 1, the following output results for a layer of the neural network:

$$[ \begin{matrix}W & b \\ 0 & 1\end{matrix} ] [ \begin{matrix}{x}^{′} \\ 1\end{matrix} ] = [ \begin{matrix}{Wx}^{′} + b \\ 1\end{matrix} ]$$

where W is the weighting matrix, b is a bias vector, and x′ is normalized input data in the form of an input vector x′=[−1;1].

Given a value distribution of the elements of input data sets x in a range of values deviating therefrom x′=[c; d], a transformation is then performed accordingly, such that the mapping x′→x takes place, and then the weight matrix W is compensated for accordingly:

$$[ \begin{matrix}\frac{d - c}{2} & \frac{d + c}{2} \\ 0 & 1\end{matrix} ] [ \begin{matrix}{x}^{′} \\ 1\end{matrix} ] = [ \begin{matrix}\frac{d - c}{2} {x}^{′} + \frac{d + c}{2} \\ 1\end{matrix} ] = [ \begin{matrix}x \\ 1\end{matrix} ]$$

Specifically, starting from a weighting matrix W and a bias vector b, by random selection according to the normalized Gaussian distribution, selected is adapted according to the following method:

$$[ \begin{matrix}W & b \\ 0 & 1\end{matrix} ] [ \begin{matrix}{x}^{′} \\ 1\end{matrix} ] = {[ \begin{matrix}W & b \\ 0 & 1\end{matrix} ] [ \begin{matrix}\frac{d - c}{2} & \frac{d + c}{2} \\ 0 & 1\end{matrix} ]}^{- 1} [ \begin{matrix}\frac{d - c}{2} & \frac{d + c}{2} \\ 0 & 1\end{matrix} ] [ \begin{matrix}{x}^{′} \\ 1\end{matrix} ] = [ \begin{matrix}W & b \\ 0 & 1\end{matrix} ] [ \begin{matrix}x \\ 1\end{matrix} ]$$

Thus, the neuron functions of a layer of neurons are subjected to the inverted transformation function in order to obtain the transformed model parameters.

The transformation into the transformed weighting matrices W′ generally corresponds to

$${W}^{′} = \frac{2}{d - c} W ,$$

and the transformation into the transformed bias vectors b′ generally corresponds to

$${b}^{′} = b + W [ \begin{matrix}- 2 \frac{c}{d - c} - 1 \\ ⋯ \\ - 2 \frac{c}{d - c} - 1\end{matrix} ] .$$

In this way, when using an input data set whose elements are not normally distributed, a normalization with respect to the initial specification of the preliminary weighting matrices and the preliminary bias vectors can be carried out.

### BRIEF DESCRIPTION OF THE DRAWINGS

Embodiments are explained in more detail below with reference to the accompanying drawings. In the drawings:

FIG. 1 shows an exemplary sensor system for determining a change point-time point in an evaluation time window;

FIG. 2 is a schematic representation of a neural network with neurons;

FIG. 3 shows a flowchart for illustrating a sequence of a training of the neural network for creating the evaluation model; and

FIG. 4 shows a schematic representation of a cylinder of an internal combustion engine in an injection system.

### DETAILED DESCRIPTION

FIG. 1 schematically shows a technical system 1 in the form of a sensor system with a sensor 2, which is designed to record and acquire continuous measurement signals of the technical system 1. The sensor 2 can correspond, for example, to a pressure sensor, a mass flow sensor, a temperature sensor, an acceleration sensor, a vibration sensor, a radiation sensor, a camera system, a radar or lidar system, or the like and can provide sensor data S in a suitable manner. The sensor data S are scanned in a scanning block 3, so that scanned sensor data E are provided.

Furthermore, one or more state variables Z of the technical system 1, which characterize a state of the technical system 1, can additionally be acquired and provided. The sampled sensor data S and the one or more state variables Z form the elements of an input vector E for a data-based evaluation model 4. For this purpose, the input vector E is directly connected to the data-based evaluation model 4 for further processing. A normalization layer is not required.

The evaluation model 4 can be designed in the form of a data-based model that is designed as a regression or classification model. The data-based evaluation model 4 can correspond in a manner known per se to a deep neural network with several layers of functionally coupled neurons. The evaluation model 4 can have a function that provides a further processing of the sensor data, a regulation as a function of the sensor data, a determination of a technical variable as a function of the sensor data, or the like.

At the output of the evaluation model 4, an output vector A is provided as evaluation result, as a function of the input vector E, from the sensor data S and the one or more state variables Z, which output vector contains a desired item of information extracted from the input vector E as a regression, one or more regression values, or as a classification one or more class assignments.

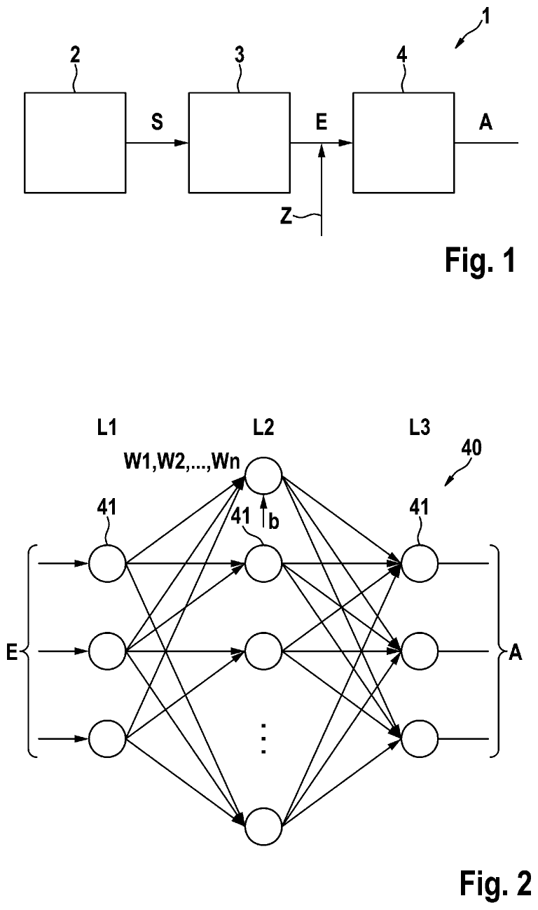

FIG. 2 schematically shows the structure of a deep neural network 40 as an example of an evaluation model 4 with several layers L, which correspond in the exemplary embodiment shown to an input layer L1, a hidden layer L2, and an output layer L3, each with several neurons 41.

Each neuron 41 executes a neuron function on supplied input variables of each neuron of the preceding layer or of the input vector E. The neuron function includes a summation of input variables, weighted according to weights W1, W2, . . . , —Wn of a weighting vector W, and a bias value b. The weights are determined by a weighting matrix W for the respective layer L2, L3, and the bias value results from a bias vector b specified for the layer in question. The summation value is also supplied to a nonlinear activation function, which can for example correspond to an ReLU function.

In the training of the neural network, the model parameters, in the form of a weighting matrix W and a bias vector b, are thus determined for each of the layers L1, L2, L3 of the neural network.

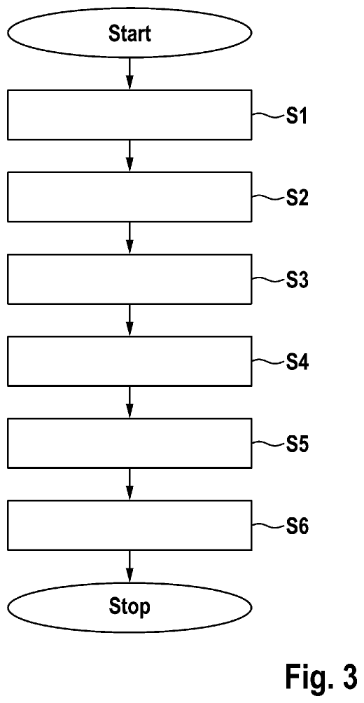

FIG. 3 shows a flowchart illustrating a method for training a neural network. For the neural network, an input vector E is provided, the elements of which can include values of, for example, a sensor signal S. These values are generally not distributed equally. Although these can be normalized, the normalization means an additional processing effort, which can lead to a considerable prolongation of the evaluation time, and in particular in real-time applications with resource-reduced hardware.

It is therefore desirable to provide a neural network as evaluation model 4 that can evaluate the values of an input vector without pre-processing for normalization. In this regard, a training method for the neural network is provided, which is described in more detail below in conjunction with the flowchart of FIG. 3.

In step S1, for this purpose, first of all, training data sets from input vectors are provided as input data set, and corresponding labels are provided. For example, the input vector can comprise sensor signal time signals and one or more state variables, and can be assigned to a label, e.g., in the form of a change point-time point as a regression value, or formatted as a classification vector.

The training data sets are analyzed in step S2 such that the values of the elements of the input vector are defined in a distribution interval. In other words, a minimum and maximum value of the input features of the input vector is determined.

Alternatively, an average value of the elements of the input vectors of all training data sets and a standard deviation of the element values can be determined. In this case, the minimum value of the distribution interval results from a subtraction of the standard deviation from the average value. Similarly, the maximum value of the distribution interval results from an addition of the standard deviation from the average value.

Furthermore, in step S3, a preliminary weighting matrix W and preliminary bias vector b is first determined, which can be used as model parameters for an initial application to the neurons of the neural network. The selection of the values of the weighting matrix or of the element values of the bias vectors is carried out by probabilistic random selection from a normalized Gaussian distribution, so that the values accordingly lie in a value range between −1 and 1.

The values of the weighting matrices or the element values of the bias vectors are subsequently re-dimensioned in step S4 according to the distribution interval of the values of the elements of the input vectors determined in step S2. The dimensioning is performed by transformation of the weighting matrix and the bias vector of each neuron layer of the neural network.

Since a selection of the values of the preliminary weighting matrix or of the element values of the preliminary bias vectors results from a normalized Gaussian distribution, and this requires that the features of the input vector are also correspondingly distributed normally. This can be achieved by corresponding normalization, but this is resource-intensive.

In this regard, the preliminary weighting matrices and the preliminary bias vectors (based on a distribution x′=[−1; 1] are modified according to the distribution interval of the values of the elements of the input vectors. The modification takes place according to the calculation rule described in general above. For an example where the distribution interval corresponds to x=[0; 1] the following applies:

$$[ \begin{matrix}0 , 5 & 0 , 5 \\ 0 & 1\end{matrix} ] [ \begin{matrix}{x}^{′} \\ 1\end{matrix} ] = [ \begin{matrix}0 , 5 {x}^{′} + 0 , 5 \\ 1\end{matrix} ] = [ \begin{matrix}x \\ 1\end{matrix} ]$$

$$\begin{matrix}[ \begin{matrix}W & b \\ 0 & 1\end{matrix} ] [ \text{} \begin{matrix}{x}^{′} \\ 1\end{matrix} ] = [ \begin{matrix}W & b \\ 0 & 1\end{matrix} ] [ \begin{matrix}2 & - 1 \\ 0 & 1\end{matrix} ] \\ [ \begin{matrix}0 , 5 & 0 , 5 \\ 0 & 1\end{matrix} ] [ \text{} \begin{matrix}{x}^{′} \\ 1\end{matrix} ] = [ \begin{matrix}2 W & W [ \begin{matrix}- 1 \\ … \\ - 1\end{matrix} ] + b \\ 0 & 1\end{matrix} ] [ \begin{matrix}x \\ 1\end{matrix} ]\end{matrix}$$

For this example, the transformation of the weighting matrix corresponds to W′=2W for the weighting matrix and

$${b}^{′} = W [ \begin{matrix}- 1 \\ … \\ - 1\end{matrix} ] + b$$

for the bias vectors b.

In step S5, the neural network is initialized with the transformed weighting matrices W′ and the transformed bias vectors b′.

Subsequently, in step S6, the training of the neural network can be started with the aid of the training data sets, starting from the parameterized model parameters W′, b′.

The above training method can be used for a plurality of applications. In particular for the evaluation of sensor data detected with different types of sensors, the outlay for normalization can thereby be considerably simplified.

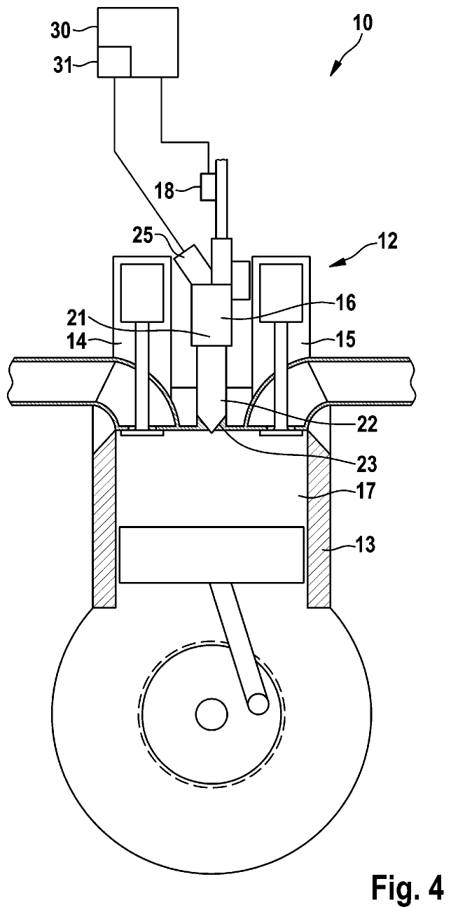

FIG. 4 shows, as an example of a technical system 1, an injection system 40 for an internal combustion engine 12 of a motor vehicle, for which a cylinder 13 (in particular, having several cylinders) is shown by way of example. The internal combustion engine 12 is preferably designed as a diesel engine with direct injection, but can also be provided as a gasoline engine.

The cylinder 13 has an inlet valve 14 and an outlet valve 15 for supplying fresh air and for discharging combustion exhaust gas.

Furthermore, fuel for operating the internal combustion engine 12 is injected via an injection valve 16 into a combustion chamber 17 of the cylinder 13. For this purpose, fuel is supplied to the injection valve via a fuel supply 18, via which fuel is provided in a manner known per se (e.g., common rail) under a high fuel pressure.

The injection valve 16 has an electromagnetically or piezoelectrically controllable actuator unit 21 that is coupled to a valve needle 22. In the closed state of the injection valve 16, the valve needle 22 sits on a needle seat 23. By actuating the actuator unit 21, the valve needle 22 is moved in the longitudinal direction and releases a part of a valve opening in the needle seat 23 in order to inject the pressurized fuel into the combustion chamber 17 of the cylinder 13.

The injection valve 16 further has a piezo sensor 25, which is arranged in the injection valve 16. The piezo sensor 25 is deformed by pressure changes in the fuel conducted through the injection valve 16 and generated as a sensor signal by a voltage signal.

The injection is controlled by a control unit 30, which specifies a quantity of fuel to be injected by energizing the actuator unit 21. The energization takes place at a specific activation time. The sensor signal is temporally sampled in the control unit 30 by means of an A/D converter 31, in particular with a sampling rate of 0.5 to 5 MHz. In this way, a sensor signal time series is obtained.

Furthermore, a pressure sensor 18 is provided in order to determine a fuel pressure upstream of the injection valve 16.

During operation of the internal combustion engine 12, the sensor signal is used to determine a correct opening or closing time of the injection valve 16. For this purpose, the sensor signal is digitized, with the aid of the A/D converter 31 and by specifying an evaluation time window, to form a corresponding evaluation point time series A, and is evaluated by the above-described feature extraction and subsequent evaluation with a trained data-based evaluation model 4, from which an opening time duration of the injection valve 16 and accordingly an injected fuel quantity can be determined as a function of the fuel pressure and further operating variables. In order to determine the opening time duration, an opening time and a closing time are, in particular, required in order to determine the opening time duration as a time difference of these variables.

In conjunction with the technical system 1, an input vector can be created from the fuel pressure, the activation time, and the sampled voltage signal as a sensor signal (sensor signal time series) and supplied to the neural network of the evaluation model In order to determine an opening and/or closing time. The variables fuel pressure, activation time, and sampled voltage signal generally provide values in different value ranges. The neural network 40 can be trained in the manner described above.

Further applications can result for data-based evaluation models that are designed for recognizing a state of the technical system 1, such as coking of an inlet tract of an internal combustion engine, from physical signals; for recognizing a defeat device in the sense of an anomaly detection; for monitoring a proper state or function, such as a drill fault detection due to a change in a torque of a drill, and the like.

In particular, for the joint evaluation of image data with individual physical variables acquired by sensors, wherein the pixels and the sensor data can have different value ranges.

What is claimed is:

1. A method for training a data-based evaluation model for determining an evaluation result, comprising:
providing training data sets that assign input data sets to one or more labels;
determining a distribution interval of values of all the input data sets;
performing an initial determination of model parameters for the data-based evaluation model as a function of the distribution interval; and
training the data-based evaluation model with the training data sets by further adaptation of the model parameters.

2. The method according to claim 1, wherein:
the determination of the distribution interval is determined as a function of a minimum value and a maximum value of all elements of the input data sets.

3. The method according to claim 1, wherein:
the data-based evaluation model corresponds to a neural network, and
the model parameters for each layer of artificial neurons of the neural network are provided as elements of a weighting matrix and of a bias vector.

4. The method according to claim 3, wherein, performing the initial determination of the model parameters for the data-based evaluation model comprises:
determining a transformation function for mapping an assumed normalized input data set with a predetermined normalized distribution onto a distribution of values of elements of the input data sets;
specifying preliminary model parameters;
applying the transformation function to the preliminary model parameters in order to obtain transformed model parameters; and
initializing the neural network with the transformed model parameters.

5. The method according to claim 4, wherein the predetermined normalized distribution of the input data sets has a distribution interval between −1 and 1.

6. The method according to claim 4, wherein neuron functions of a layer of the layers of artificial neurons are subjected to an inverted version of the transformation function in order to obtain the transformed model parameters.

7. An apparatus for carrying out the method according to claim 1.

8. A computer program product including instructions which, when executing the computer program product by a computer, cause the computer to execute the method according to claim 1.

9. A non-transitory machine-readable storage medium comprising instructions which, when executed by a computer, cause the computer to execute the method according to claim 1.

10. The method according to claim 2, wherein the distribution interval is determined as a function of an average value and a standard deviation of the values of all the elements of the input data sets.
